(19) United States
(12) Patent Application Publication
(10) Pub. No.: US 2021/0383276 A1
(43) Pub. Date: Dec. 9, 2021

(54) BUILDING SYSTEM WITH A RECOMMENDATION ENGINE THAT OPERATES WITHOUT STARTING DATA

(71) Applicant: Johnson Controls Technology Company, Auburn Hills, MI (US)

(72) Inventors: Vish Ramamurti, San Leandro, CA (US); Wenwen Zhao, Santa Clara, CA (US); Chenlu Zhang, Milwaukee, WI (US); Kelsey Carle Schuster, Wauwatosa, WI (US); Young M. Lee, Old Westbury, NY (US)

(73) Assignee: Johnson Controls Technology Company, Auburn Hills, MI (US)

(21) Appl. No.: 17/339,322

(22) Filed: Jun. 4, 2021

Related U.S. Application Data
(60) Provisional application No. 63/035,281, filed on Jun. 5, 2020.

(51) Int. Cl. G06N 20/00; G06N 5/04; G05B 13/02

(52) U.S. Cl. CPC G06N 20/00; G05B 13/0265; G06N 5/04

(57) ABSTRACT

A building system including one or more memory devices configured to store instructions thereon, that, when executed by one or more processors, cause the one or more processors to generate building recommendations based on recommendation requests with a model of a first model type when less than a predefined amount of model training data is available and receive feedback data on the recommendation requests generated by the model of the first model type. The instructions cause the one or more processors to transition from generating the building recommendations by the model of the first model type to a second model of a second model type by comparing performance of the first model type to the second model type based on the feedback data.

### CROSS-REFERENCE TO RELATED PATENT APPLICATION

This application claims the benefit of, and priority to, U.S. Provisional Patent Application No. 63/035,281 filed Jun. 5, 2020, the entirety of which is incorporated by reference herein.

### BACKGROUND

The present disclosure relates generally to building systems that manage a building. The present disclosure relates more particular to recommendation generation in buildings.

Some recommendation engines can be used to generate a recommendation to an end user. For example, a movie platform can recommend movies to a user that the user may be interested in watching, a product sales platform can recommend products to a user that the user may be interested in purchasing, a video platform could recommend videos to a user that the user may be interested in watching, and a news platform could recommend news content to a user that the user may be interested in reading. However, these platforms collect and store a significant amount of user data and train recommendation models for making the recommendations based on the user data. In a building, there may not be a significant amount of collected user data, especially when the building is first commissioned, and therefore a recommendation engine for a building may not be able to train a recommendation model to make recommendations to a user or other system.

### SUMMARY

A building system including one or more memory devices configured to store instructions thereon, that, when executed by one or more processors, cause the one or more processors to generate building recommendations based on recommendation requests with a model of a first model type when less than a predefined amount of model training data is available. The instructions cause the one or more processors to receive feedback data on the recommendation requests generated by the model of the first model type and transition from generating the building recommendations by the model of the first model type to a second model of a second model type by comparing performance of the first model type to the second model type based on the feedback data.

In some embodiments, comparing the performance of the first model type to the second model type based on the feedback data includes comparing a first performance of a first model of the first model type and a second performance of the second model of the second model type to an evolving reference model of the first model type based on the feedback data.

In some embodiments, the instructions cause the one or more processors to partition the feedback data into a first data set and a second data set, generate first recommendations for recommendation requests of the second data set with a first model of the first model type based on the first data set, generate second recommendations for the recommendation requests of the second data set with the second model of the second model type based on the first data set, and compare performance of the first model of the first model type and the second model of the second model type by generating rewards of the first model and the second model with the first recommendations, the second recommendations, and an evolving reference model of the first model type, wherein the evolving reference model of the first model type is based on the first data set and the second data set.

In some embodiments, the first model of the first model type and the evolving reference model of the first model type are both an evolving matrix method (EMM) model. In some embodiments, the second model of the second model type is a collaborative filtering (CF) model.

In some embodiments, the model is a matrix of an evolving matrix method (EMM). In some embodiments, the instructions cause a plurality of values of the matrix to be updated overtime as the feedback data is collected.

In some embodiments, the matrix includes rows and columns, wherein one of the rows or the columns represent a plurality of users and one of the rows and the columns represent a plurality of possible recommendations.

In some embodiments, each intersection of the rows and the columns represents the plurality of values. In some embodiments, the instructions cause the one or more processors to receive a recommendation request associated with one or more users, generate a score for each of the plurality of possible recommendations based on one or more of the plurality of values, the one or more of the plurality of values associated with the one or more users, and select a possible recommendation associated with a highest score from the plurality of possible recommendations.

In some embodiments, the instructions cause the one or more processors to receive second feedback data on second building recommendations generated by the second model of the second model type and transition from generating the second building recommendations by the second model of the second model type to a third model of a third model type by comparing performance of the second model type to the third model type based on the second feedback data and an evolving reference model of the first model type.

In some embodiments, the second model of the second model type is a collaborative filtering (CF) model and the third model of the third model type is a supervised learning (SL) model.

In some embodiments, the instructions cause the one or more processors to receive third feedback data on third building recommendations generated by the third model of the third model type and transition from generating the third building recommendations by the third model of the third model type to a fourth model of a fourth model type by comparing performance of the third model type to the fourth model type based on the third feedback data and the evolving reference model of the first model type.

In some embodiments, the third model of the third model type is a supervised learning (SL) model and the fourth model of the fourth model type is a reinforcement learning (RL) model.

Another implementation of the present disclosure is a method including generating, by a processing circuit, building recommendations based on recommendation requests with a model of a first model type when less than a predefined amount of model training data is available. The method includes receiving, by the processing circuit, feedback data on the recommendation requests generated by the model of the first model type and transitioning, by the processing circuit, from generating the building recommendations by the model of the first model type to a second model of a second model type by comparing performance of the first model type to the second model type based on the feedback data.

In some embodiments, comparing the performance of the first model type to the second model type based on the feedback data includes comparing a first performance of a first model of the first model type and a second performance of the second model of the second model type to an evolving reference model of the first model type based on the feedback data.

In some embodiments, the method further includes receiving, by the processing circuit, second feedback data on second building recommendations generated by the second model of the second model type and transitioning, by the processing circuit, from generating the second building recommendations by the second model of the second model type to a third model of a third model type by comparing performance of the second model type to the third model type based on the second feedback data and an evolving reference model of the first model type.

In some embodiments, the method includes partitioning, by the processing circuit, the feedback data into a first data set and a second data set, generating, by the processing circuit, first recommendations for recommendation requests of the second data set with a first model of the first model type based on the first data set, generating, by the processing circuit, second recommendations for the recommendation requests of the second data set with the second model of the second model type based on the first data set, and comparing, by the processing circuit, the performance of the first model of the first model type and the second model of the second model type by generating rewards of the first model and the second model with the first recommendations, the second recommendations, and an evolving reference model of the first model type, wherein the evolving reference model of the first model type is based on the first data set and the second data set.

In some embodiments, the first model of the first model type and the evolving reference model of the first model type are both an evolving matrix method (EMM) model. In some embodiments, the second model of the second model type is a collaborative filtering (CF) model.

In some embodiments, the model is a matrix of an evolving matrix method (EMM). In some embodiments, the method further includes causing, by the processing circuit, a plurality of values of the matrix to be updated overtime as the feedback data is collected.

In some embodiments, the matrix includes rows and columns, wherein one of the rows or the columns represent a plurality of users and one of the rows and the columns represent a plurality of possible recommendations.

In some embodiments, each intersection of the rows and the columns represents the plurality of values. In some embodiments, the method further includes receiving, by the processing circuit, a recommendation request associated with one or more users, generating, by the processing circuit, a score for each of the plurality of possible recommendations based on one or more of the plurality of values, the one or more of the plurality of values associated with the one or more users, and selecting, by the processing circuit, a possible recommendation associated with a highest score from the plurality of possible recommendations.

In some embodiments, a building system includes one or more memory devices configured to store instructions thereon, that, when executed by one or more processors, cause the one or more processors to generate building recommendations based on recommendation requests with a matrix of an evolving matrix method (EMM) when less than a predefined amount of model training data is available, wherein one of a row or a column of the matrix represents a plurality of users and one or more of the row or the column represent a plurality of possible recommendations. The instructions cause the one or more processors to receive feedback data on the recommendation requests generated by the matrix, update a plurality of values of the matrix with the feedback data, and generate additional building recommendations with the matrix updated based on the feedback data.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to an exemplary embodiment.

FIG. 2 is a block diagram of a building automation system (BAS) that may be used to monitor and/or control the building of FIG. 1, according to an exemplary embodiment.

FIG. 3 is a chart of an evolving matrix of an evolving matrix method (EMM) for recommending a meeting room to an employee, according to an exemplary embodiment.

FIG. 4 is a block diagram of a meeting room recommendation system that can train models to make meeting room recommendations, according to an exemplary embodiment.

FIG. 5 is a block diagram of application programming interface (API) calls and endpoints for generating meeting room recommendations, according to an exemplary embodiment.

FIG. 6 is a flow diagram of a process of training recommendation models when no starting data is available that can be performed by the meeting room recommendation system of FIG. 4, according to an exemplary embodiment.

FIG. 7 is a chart of multiple experiments where the meeting room recommendation system of FIG. 4 switches between using a EMM model and a collaborative filtering (CF) model, according to an exemplary embodiment.

FIG. 8 is a code snippet of uniform resource locators (URLs) for EMM models, CF models, supervised learning (SL) models, and reinforcement learning (RL) models, according to an exemplary embodiment.

### DETAILED DESCRIPTION

### Overview

Referring generally to the FIGURES, systems and methods are shown for generating recommendations in a building when no prior feedback data is available for generating the recommendations, according to various exemplary embodiments. To operate when little or no prior data is available, a building system can be configured to transition between recommender models at appropriate times as user feedback data is aggregated. In some embodiments, the building system is configured to generate meeting room recommendations for a meeting. The building system can be configured to transition between recommender models as feedback of prior meeting room recommendations is collected.

In contrast, some systems for generating recommendations may need to wait until sufficient feedback data becomes available for training a single recommendation model. This results in a period of time where recommendations are unavailable. Waiting for data to be collected before generating recommendations can require months or even years in some cases. Furthermore, using a single recommendation technique may not return the best results.

While the model training systems and methods described herein are described with reference to meeting room recommendations, the model training systems and methods described herein can be applied to generating recommendations for allocating workspaces to employees, recommending nearby restaurants to a group of employees, recommending the cuisine while ordering food at work, displaying content on a digital wall display in a building, selecting music to be played at a company gathering, identifying guest speakers for a company, vacation planning for multiple friends, suggesting a television program for a family or friends to watch, etc. In some embodiments, the building system could be configured to perform a single recommendation such as recommending food or beverage operations to employees based on past choices.

### Building Management System and HVAC System

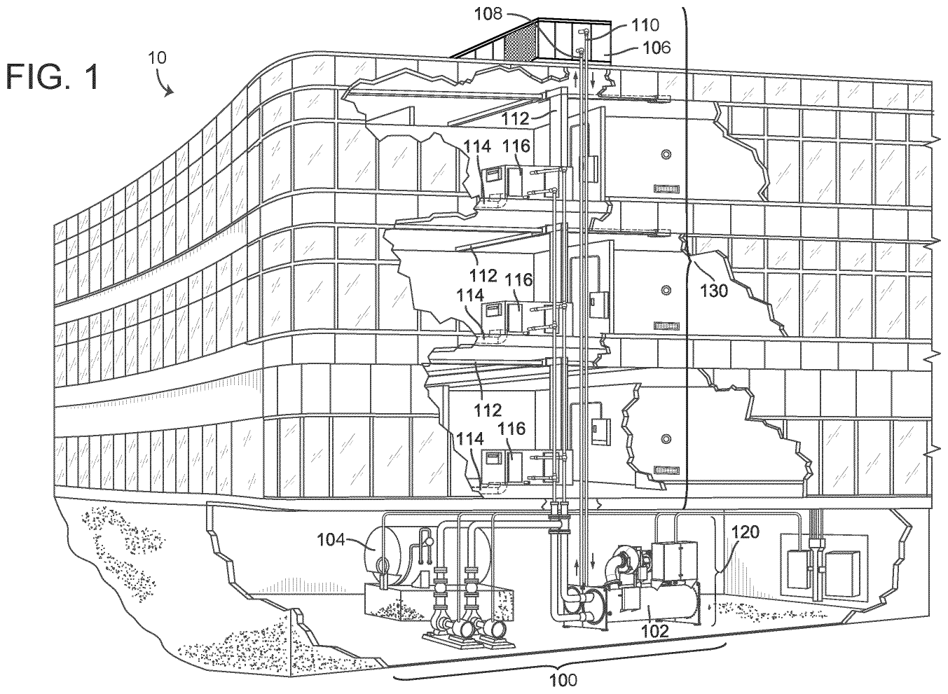

Referring now to FIG. 1, an exemplary building management system (BMS) and HVAC system in which the systems and methods of the present invention can be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, and/or any other system that is capable of managing building functions or devices, or any combination thereof.

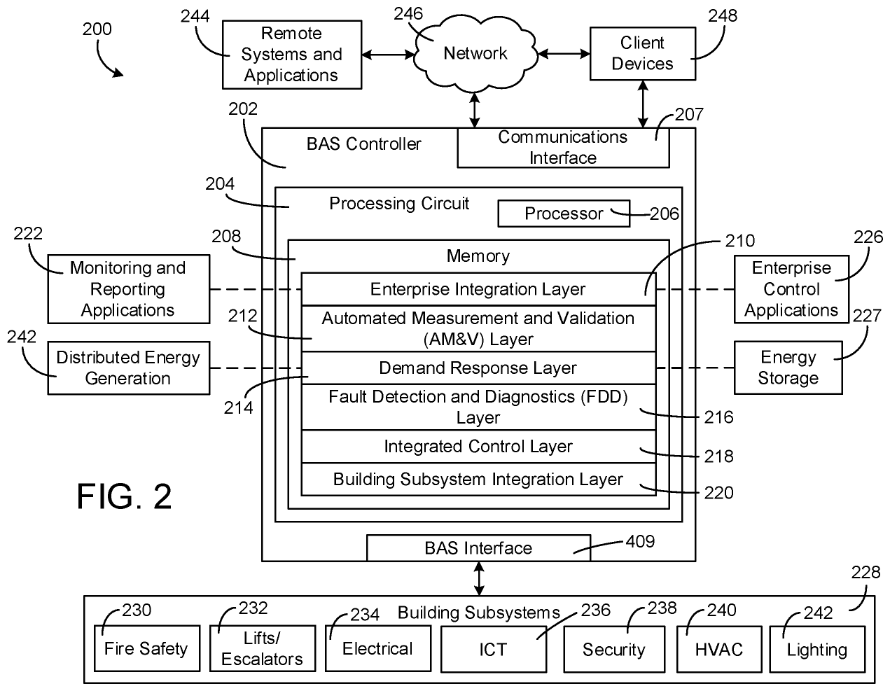

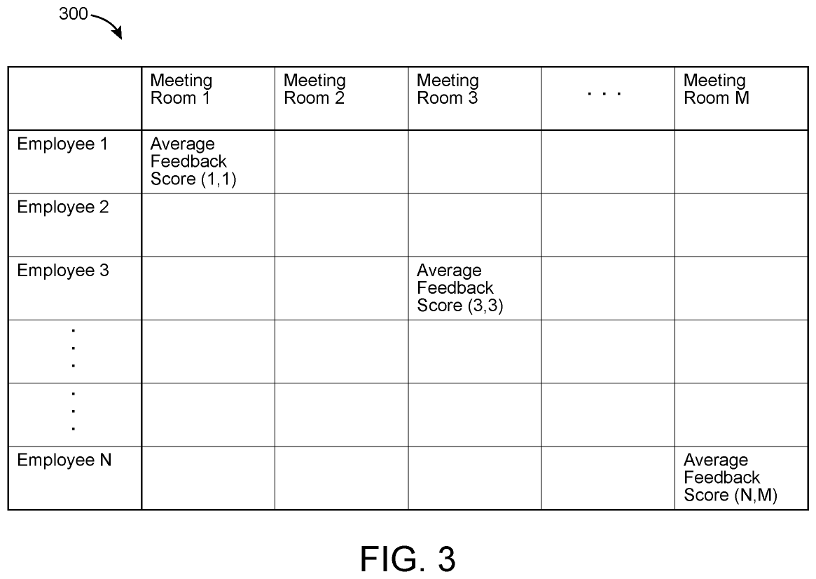

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

Referring now to FIG. 2, a block diagram of a building automation system (BAS) 200 is shown, according to an exemplary embodiment. BAS 200 can be implemented in building 10 to automatically monitor and control various building functions. BAS 200 is shown to include BAS controller 202 and a plurality of building subsystems 228. Building subsystems 228 are shown to include a building electrical subsystem 234, an information communication technology (ICT) subsystem 236, a security subsystem 238, a HVAC subsystem 240, a lighting subsystem 242, a lift/escalators subsystem 232, and a fire safety subsystem 230. In various embodiments, building subsystems 228 can include fewer, additional, or alternative subsystems. For example, building subsystems 228 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 228 include a waterside system and/or an airside system. A waterside system and an airside system are described with further reference to U.S. patent application Ser. No. 15/631,830 filed Jun. 23, 2017, the entirety of which is incorporated by reference herein.

Each of building subsystems 228 can include any number of devices, controllers, and connections for completing its individual functions and control activities. HVAC subsystem 240 can include many of the same components as HVAC system 100, as described with reference to FIG. 1. For example, HVAC subsystem 240 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 242 can include any number of light fixtures, ballasts, lighting sensors, dimmers, or other devices configured to controllably adjust the amount of light provided to a building space. Security subsystem 238 can include occupancy sensors, video surveillance cameras, digital video recorders, video processing servers, intrusion detection devices, access control devices and servers, or other security-related devices.

Still referring to FIG. 2, BAS controller 266 is shown to include a communications interface 207 and a BAS interface 209. Interface 207 can facilitate communications between BAS controller 202 and external applications (e.g., monitoring and reporting applications 222, enterprise control applications 226, remote systems and applications 244, applications residing on client devices 248, etc.) for allowing user control, monitoring, and adjustment to BAS controller 266 and/or subsystems 228. Interface 207 can also facilitate communications between BAS controller 202 and client devices 248. BAS interface 209 can facilitate communications between BAS controller 202 and building subsystems 228 (e.g., HVAC, lighting security, lifts, power distribution, business, etc.).

Interfaces 207, 209 can be or include wired or wireless communications interfaces (e.g., jacks, antennas, transmitters, receivers, transceivers, wire terminals, etc.) for conducting data communications with building subsystems 228 or other external systems or devices. In various embodiments, communications via interfaces 207, 209 can be direct (e.g., local wired or wireless communications) or via a communications network 246 (e.g., a WAN, the Internet, a cellular network, etc.). For example, interfaces 207, 209 can include an Ethernet card and port for sending and receiving data via an Ethernet-based communications link or network. In another example, interfaces 207, 209 can include a Wi-Fi transceiver for communicating via a wireless communications network. In another example, one or both of interfaces 207, 209 can include cellular or mobile phone communications transceivers. In one embodiment, communications interface 207 is a power line communications interface and BAS interface 209 is an Ethernet interface. In other embodiments, both communications interface 207 and BAS interface 209 are Ethernet interfaces or are the same Ethernet interface.

Still referring to FIG. 2, BAS controller 202 is shown to include a processing circuit 204 including a processor 206 and memory 208. Processing circuit 204 can be communicably connected to BAS interface 209 and/or communications interface 207 such that processing circuit 204 and the various components thereof can send and receive data via interfaces 207, 209. Processor 206 can be implemented as a general purpose processor, an application specific integrated circuit (ASIC), one or more field programmable gate arrays (FPGAs), a group of processing components, or other suitable electronic processing components.

Memory 208 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 208 can be or include volatile memory or non-volatile memory. Memory 208 can include database components, object code components, script components, or any other type of information structure for supporting the various activities and information structures described in the present application. According to an exemplary embodiment, memory 208 is communicably connected to processor 206 via processing circuit 204 and includes computer code for executing (e.g., by processing circuit 204 and/or processor 206) one or more processes described herein.

In some embodiments, BAS controller 202 is implemented within a single computer (e.g., one server, one housing, etc.). In various other embodiments BAS controller 202 can be distributed across multiple servers or computers (e.g., that can exist in distributed locations). Further, while FIG. 2 shows applications 222 and 226 as existing outside of BAS controller 202, in some embodiments, applications 222 and 226 can be hosted within BAS controller 202 (e.g., within memory 208).

Still referring to FIG. 2, memory 208 is shown to include an enterprise integration layer 210, an automated measurement and validation (AM&V) layer 212, a demand response (DR) layer 214, a fault detection and diagnostics (FDD) layer 216, an integrated control layer 218, and a building subsystem integration later 220. Layers 210-220 is configured to receive inputs from building subsystems 228 and other data sources, determine optimal control actions for building subsystems 228 based on the inputs, generate control signals based on the optimal control actions, and provide the generated control signals to building subsystems 228 in some embodiments. The following paragraphs describe some of the general functions performed by each of layers 210-220 in BAS 200.

Enterprise integration layer 210 can be configured to serve clients or local applications with information and services to support a variety of enterprise-level applications. For example, enterprise control applications 226 can be configured to provide subsystem-spanning control to a graphical user interface (GUI) or to any number of enterprise-level business applications (e.g., accounting systems, user identification systems, etc.). Enterprise control applications 226 can also or alternatively be configured to provide configuration GUIs for configuring BAS controller 202. In yet other embodiments, enterprise control applications 226 can work with layers 210-220 to optimize building performance (e.g., efficiency, energy use, comfort, or safety) based on inputs received at interface 207 and/or BAS interface 209.

Building subsystem integration layer 220 can be configured to manage communications between BAS controller 202 and building subsystems 228. For example, building subsystem integration layer 220 can receive sensor data and input signals from building subsystems 228 and provide output data and control signals to building subsystems 228. Building subsystem integration layer 220 can also be configured to manage communications between building subsystems 228. Building subsystem integration layer 220 translate communications (e.g., sensor data, input signals, output signals, etc.) across a plurality of multi-vendor/multi-protocol systems.

Demand response layer 214 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 224, from energy storage 227, or from other sources. Demand response layer 214 can receive inputs from other layers of BAS controller 202 (e.g., building subsystem integration layer 220, integrated control layer 218, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an exemplary embodiment, demand response layer 214 includes control logic for responding to the data and signals it receives. These responses can include communicating with the control algorithms in integrated control layer 218, changing control strategies, changing setpoints, or activating/deactivating building equipment or subsystems in a controlled manner. Demand response layer 214 can also include control logic configured to determine when to utilize stored energy. For example, demand response layer 214 can determine to begin using energy from energy storage 227 just prior to the beginning of a peak use hour.

In some embodiments, demand response layer 214 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 214 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 214 can further include or draw upon one or more demand response policy definitions (e.g., databases, XML, files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 218 can be configured to use the data input or output of building subsystem integration layer 220 and/or demand response later 214 to make control decisions. Due to the subsystem integration provided by building subsystem integration layer 220, integrated control layer 218 can integrate control activities of the subsystems 228 such that the subsystems 228 behave as a single integrated supersystem. In an exemplary embodiment, integrated control layer 218 includes control logic that uses inputs and outputs from a plurality of building subsystems to provide greater comfort and energy savings relative to the comfort and energy savings that separate subsystems could provide alone. For example, integrated control layer 218 can be configured to use an input from a first subsystem to make an energy-saving control decision for a second subsystem. Results of these decisions can be communicated back to building subsystem integration layer 220.

Integrated control layer 218 is shown to be logically below demand response layer 214. Integrated control layer 218 can be configured to enhance the effectiveness of demand response layer 214 by enabling building subsystems 228 and their respective control loops to be controlled in coordination with demand response layer 214. This configuration can reduce disruptive demand response behavior relative to conventional systems. For example, integrated control layer 218 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 218 can be configured to provide feedback to demand response layer 214 so that demand response layer 214 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 218 is also logically below fault detection and diagnostics layer 216 and automated measurement and validation layer 212. Integrated control layer 218 can be configured to provide calculated inputs (e.g., aggregations) to these higher levels based on outputs from more than one building subsystem.

Automated measurement and validation (AM&V) layer 212 can be configured to verify that control strategies commanded by integrated control layer 218 or demand response layer 214 are working properly (e.g., using data aggregated by AM&V layer 212, integrated control layer 218, building subsystem integration layer 220, FDD layer 216, or otherwise). The calculations made by AM&V layer 212 can be based on building system energy models and/or equipment models for individual BAS devices or subsystems. For example, AM&V layer 212 can compare a model-predicted output with an actual output from building subsystems 228 to determine an accuracy of the model.

Fault detection and diagnostics (FDD) layer 216 can be configured to provide on-going fault detection for building subsystems 228, building subsystem devices (i.e., building equipment), and control algorithms used by demand response layer 214 and integrated control layer 218. FDD layer 216 can receive data inputs from integrated control layer 218, directly from one or more building subsystems or devices, or from another data source. FDD layer 216 can automatically diagnose and respond to detected faults. The responses to detected or diagnosed faults can include providing an alarm message to a user, a maintenance scheduling system, or a control algorithm configured to attempt to repair the fault or to work-around the fault.

FDD layer 216 can be configured to output a specific identification of the faulty component or cause of the fault (e.g., loose damper linkage) using detailed subsystem inputs available at building subsystem integration layer 220. In other exemplary embodiments, FDD layer 216 is configured to provide “fault” events to integrated control layer 218 which executes control strategies and policies in response to the received fault events. According to an exemplary embodiment, FDD layer 216 (or a policy executed by an integrated control engine or business rules engine) can shut-down systems or direct control activities around faulty devices or systems to reduce energy waste, extend equipment life, or assure proper control response.

FDD layer 216 can be configured to store or access a variety of different system data stores (or data points for live data). FDD layer 216 can use some content of the data stores to identify faults at the equipment level (e.g., specific chiller, specific AHU, specific terminal unit, etc.) and other content to identify faults at component or subsystem levels. For example, building subsystems 228 can generate temporal (i.e., time-series) data indicating the performance of BAS 200 and the various components thereof. The data generated by building subsystems 228 can include measured or calculated values that exhibit statistical characteristics and provide information about how the corresponding system or process (e.g., a temperature control process, a flow control process, etc.) is performing in terms of error from its setpoint. These processes can be examined by FDD layer 216 to expose when the system begins to degrade in performance and alarm a user to repair the fault before it becomes more severe.

### Recommendation Methods

Some methods for generating recommendations include collaborative filtering methods, content based filtering methods, and hybrid methods. The collaborative filtering method includes identifying similar users and selected preferences of similar users. The collaborative filtering method can include finding similarities between a particular user with other users. The similarities can be used as weights to weight other user preferences used to predict the preference for user, u to an item, i. In some embodiments, the similarity can be computed using a Pearson correlation or a cosine similarity. Matrix factorization is one type of collaborative filtering. Matrix factorization identifies preferences to latent features in items.

However, collaborating filtering, including all of the aforementioned forms of collaborative filtering, suffer from a “cold start” problem. Collaborative filtering performs poorly when a new user or a new item is added and there is no data to compare against to generate a recommendation. For this reason, collaborative filtering cannot be applied when no feedback data is available, e.g., when a new user or item is introduced to the collaborative filtering method.

Another method of recommendations is content based filtering where recommendations are made based on attributes of content. Content based filtering includes considering attributes of the items to be recommended. For example, content based filtering could recommend a movie based on movie attributes (e.g., genre, director, actor, year etc. or textual content of articles that can be extracted by natural language processing). For a meeting room, the attributes could be attributes of the room (e.g., window, size, distance, amenities etc.). In some embodiments, content based filtering can be applied to text documents with bag-of-words, term frequency-inverse document frequency (tf-idf), word2vec, etc. Some forms of content based filtering include using neural networks and/or machine learning that receives attributes of content as features for training and/or inference.

One form of machine learning is supervised learning. Supervised learning can learn complex user-item interactions, extract user related features, and make recommendations. Supervised learning can treat recommendation generation as a classification problem. Some recommendations such as video recommendations for video recommendation platforms, application download recommendations for an application download platform, etc. can utilize supervised learning. However, using a supervised learning can require that recommendations do not change significantly with time and that a significant amount of training data is available.

Another form of machine learning is reinforcement learning. Reinforcement learning may be applicable for recommendations over time since features and user preferences of content may have a dynamic nature of features and preferences (e.g., a news story becomes outdated quickly). Reinforcement learning may determine that a sum of future rewards is more important than current reward (e.g., a user should keep coming back to news stories, one time story not as important as themed stories). For news stories, reinforcement learning can identify that user return pattern is an input more important that click through rate.

As another example, set point recommendations throughout the day based on future sum of fifteen minute power consumption costs for the rest of the day could be determined based on reinforcement learning as opposed to just the immediate fifteen minute consumption. Reinforcement learning can perform well because it allows for exploration in addition to exploitation. For example, a user may latch on to a different news theme over time. However, reinforcement learning may require a significant amount of training data.

Recommendation Engine that Operates without Starting Data

Referring now to FIG. 3, an evolving matrix 300 of an evolving matrix method (EMM) for recommending a meeting room to an employee (or employees) is shown, according to an exemplary embodiment. In some embodiments, a building system (e.g., the processing components of the BAS controller 202 of FIG. 2 or any other computing system or device described herein) can utilize the evolving matrix 300 to make meeting room recommendations. The evolving matrix 300 may be an approach for generating recommendations when no feedback data is available. In some embodiments, the building system may gradually build up a lookup table, i.e., the matrix 300 may evolve overtime.

The evolving matrix 300 includes rows. The rows of the evolving matrix 300 represent different employees of a building, employees 1-N. Furthermore, the evolving matrix 300 includes meeting rooms, meeting rooms 1-M. For each intersection of the rows and columns is a feedback score. In some embodiments, the feedback scores range from 0 to 10. In some embodiments, when the evolving matrix 300 is first implemented, all the cells include a middle value, e.g., 5 when the feedback scores range from 0 to 10. Cell entries can be an average feedback value, a moving window average, a latest value of feedback, etc.

The building system can be configured to select a meeting room for an employee or a group of employees using the evolving matrix 300. For example, if four employees, a, b, c, and d want to reserve a meeting room and four meeting rooms, x, y, z, and w are available, the building system can add up the values of column corresponding to x for employees a, b, c, and d of the matrix 300. The building system can do the same operation for columns corresponding to meeting rooms y, z, and w of the matrix 300. The building system can select the meeting room corresponding to the largest sum.

When the building system operates the evolving matrix 300 based on a simulated data set and the results are compared to other recommendation methods, it is found that the average reward on a test set is larger with the evolving matrix 300 than compared to RL or SL machine learning model when the data used is limited to a predefined amount (e.g., a small amount.) Furthermore, the average reward of the evolving matrix 300 is larger than collaborative filtering methods depending on amount of available feedback data and how correlated meeting room preferences are between users.

Furthermore, the time it takes to create the evolving matrix 300 is only a fraction of the time it takes for a neural network to learn and/or estimate rewards. Furthermore, the evolving matrix 300 is able to work with any feedback score distribution and can change with time. The evolving matrix 300 can be implemented with no (or a small amount) of training data and can be gradually updated over time by the building system.

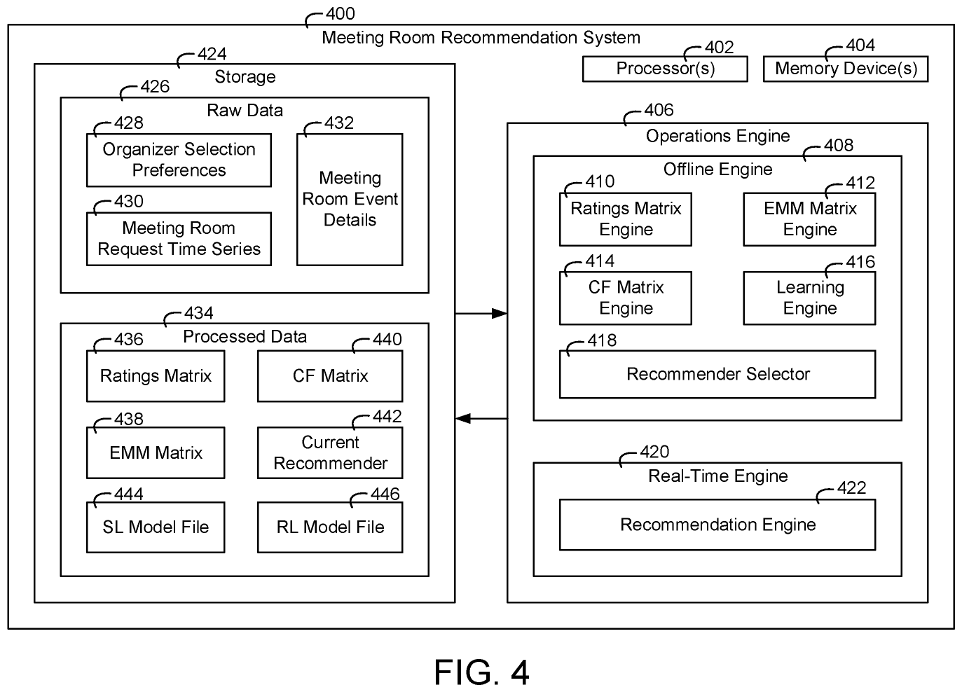

Referring now to FIG. 4, a block diagram of a meeting room recommendation system 400 that can train models to make meeting room recommendations is shown, according to an exemplary embodiment. The meeting room recommendation system 400 includes processor(s) 402 and memory device(s) 404. The processor(s) 402 can be implemented as a general purpose processor, an application specific integrated circuit (ASIC), one or more field programmable gate arrays (FPGAs), a group of processing components, or other suitable electronic processing components.

The memory device(s) 404 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory device(s) 404 can be or include volatile memory or non-volatile memory. The memory device(s) 404 can include database components, object code components, script components, or any other type of information structure for supporting the various activities and information structures described in the present application. According to an exemplary embodiment, the memory device(s) 404 is communicably connected to processor(s) 402 and includes computer code for executing (e.g., by the processor(s) 402) one or more processes described herein.

The storage 424 can be a memory device (e.g., the same as or similar to the memory device(s) 404). The storage 424 includes raw data 426 and processed data 434. The raw data includes organizer selection preferences 428, meeting room request time series 430, and meeting room event details 432.

The meeting room request time series 430 can include various pieces of information associated with a request for a meeting room. The information can include a meeting request identifier, a meeting time, a meeting duration, a meeting title, a meeting location, an indication of attendees, meeting room comments from one or multiple attendees, a rating of each attendee, temperature or lighting preferences of one or multiple attendees, food or beverages ordered by one or multiple attendees, requirements for a meeting room (e.g., size, windows, amenities, etc.). The meeting room event details 432 can include information about the meeting room, e.g., a size of the meeting room, windows of the meeting room, amenities within the meeting room, etc.

The organizer selection preferences 428 can include the preferences of an organizer of a meeting. The preferences 428 can further include other preferences of attendees. The preference information can be received from a user application. The information can include a meeting room rating, food, and/or beverage preferences, etc. In some embodiments, the user application allows a user to order food or beverages and/or manually select a meeting room from a list of available meeting rooms.

The processed data 434 includes a ratings matrix 436, a CF matrix 440, an EMM matrix 438 (e.g., an EMM matrix the same as, or similar to the EMM matrix 300 as described with reference to FIG. 3), a current recommender 442, a SL model file 444, and a RL model file 446. The operations engine 406 includes an offline engine 408 and a real-time engine 420. The offline engine 408 includes a ratings matrix engine 410, an EMM matrix engine 412, a CF matrix engine 414, a learning engine 416, and a recommender selector 418. The learning engine 416 can be configured to perform supervised learning and/or reinforcement learning. The real-time engine 420 includes a recommendation engine 422.

The recommender selector 418 can be configured to select the EMM matrix 438, the CF matrix 440, the SL model file 444, or the RL model file 446. In some embodiments, when data is limited or preferences are uncorrelated, the EMM matrix 438 performs well. However, when available feedback information is limited but not too small (and when the preferences of multiple users are correlated), the CF matrix 440 performs well. Generally, the greater the correlation, less data is required for the CF matrix 440 to perform well. Furthermore, the SL model file 444 performs better than the CF matrix 440 for complex correlations when a significant amount of feedback data is available. The RL model file 446 can perform better than the SL model file 444 in allocating meeting rooms in certain trajectories over other trajectories.

In some embodiments, the recommender selector 418 can be configured to begin generating recommendations with the EMM matrix 438. However, it is unknown whether the EMM matrix 438 will outperform the CF matrix 440, the SL model file 444, or the RL model file 446. The recommender selector 418 can test the performance of the alternative recommender (e.g., the CF matrix 440, the SL model file 444, and/or the RL model file 446) compared to the EMM matrix 438 from real feedback data before the operations engine 406 can switch from the EMM matrix 438 to other models.

The ratings matrix engine 410 can receive meeting room event details 432 and the organizer selection preferences 428 and generate the ratings matrix 438. The ratings matrix 436 may indicate current feedback that users have applied to specific meeting rooms. The EMM matrix engine 412 can receive the ratings matrix 436 as an input and output the EMM matrix 438. In some embodiments, the EMM matrix engine 412 updates the EMM matrix 438 over time with the ratings matrix 436 as feedback is received.

Furthermore, the CF matrix engine 414 can receive the ratings matrix 436 as an input and output the CF matrix 440. The learning engine 416 can receive the meeting room request time series 430 and attendee feedback data and output the SL model file 444 and/or the RL model file 446 which may each include a model architecture and/or models weights. The learning engine 416 can apply various types of machine learning algorithms, e.g., one-dimensional optimization, multidimensional optimization (e.g., gradient descent, Newton's method, conjugate gradient, quasi Newton, Levenberg Marquardt, etc.), and/or any other optimization algorithm.

The recommender selector 418 can receive the EMM matrix 438, the CF matrix 440, SL model file 444, the RL model file 446, and the meeting room request time series 430 and output a recommendation method, i.e., a selection of one of the EMM matrix 438, the CF matrix 440, SL model file 444, and the RL model file 446. Based on the selection, the recommendation engine 433 can generate a meeting room recommendation based on the selected method and the raw data 426.

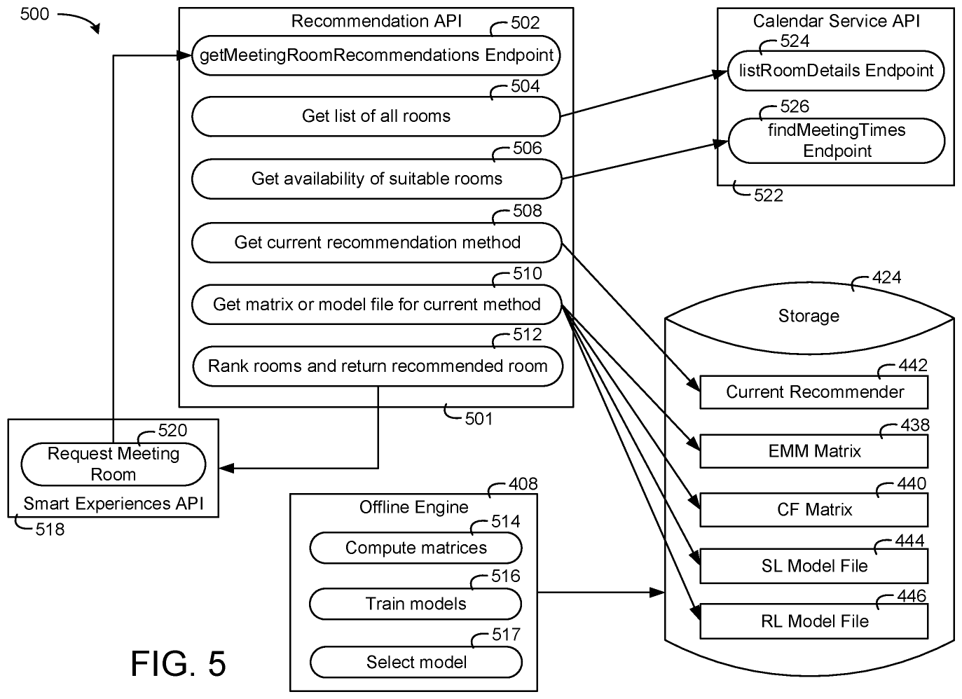

Referring now to FIG. 5, a block diagram 500 of application programming interface (API) calls and endpoints for generating meeting room recommendations is shown, according to an exemplary embodiment. FIG. 5 includes a smart experiences API 518, a recommendation API 501, the calendar service API 522, the storage 424 described with reference to FIG. 4, and the offline engine 408 described with reference to FIG. 4.

The smart experiences API 518 can be an API for an application for requesting meeting rooms. The smart experiences API 518 may interface with an application run on a user device, a server, and/or any other computing system. The recommendation API 501 may be an API of the meeting room recommendation system 400 and can handle receiving requests for meeting room recommendations and communicating with a calendar service API 522 and the storage 424. The calendar service API 522 can be an API of a calendar service that manages meeting scheduling for a building.

The smart experiences API 518 can execute an operation 520 to request a meeting room from the recommendation API 502. The request can be directed to a “getMeetingRoomRecommendations” endpoint 502 of the recommendation API. The recommendation API 501 can include an operation 504 to get availability of suitable rooms based on the meeting room request. The operation 504 can communicate with a “listRoomDetails” endpoint 524 which may store a list of rooms. The recommendation API 501 can include an operation 506 to get availability of suitable rooms from a “findMeetingTimes” endpoint 526 of the calendar service API. The suitable rooms may be based on details of the rooms received from the operation 504 and details of the request received from the smart experiences API 518.

The recommendation API 501 includes an operation 508 to get a current recommendation method by retrieving the current recommender 442. The current recommender 442 may be an indicator that indicates one of the EMM matrix 438, the CF matrix 440, the SL model file 444, and the RL model file 446. The recommendation API 501 includes an operation 510 to get a matrix or model file for a current method. Based on a selected model and the model request (e.g., a model selected in the operation 517 performed by the offline engine 408), a model recommendation can be generated. An operation 512 of the recommendation API 501 can rank rooms and provide one room of the ranked rooms (a highest ranked rom) to the smart experiences API 518.

The offline engine 408 includes three operations (but may include any number of operations), a compute matrices operation 514, a train models operation 516, and a select model operation 517. The compute matrices operation 514 can compute the EMM matrix 438, the ratings matrix 436, and/or the CF matrix 440 based on feedback data. The train models operation 516 can train the SL model file 444 and/or the RL model file 446 based on the feedback data. The operation 517 may select one of the EMM matrix 438, the CF matrix 440, the SL model file 444, and the RL model file 446 as the current recommendation method.

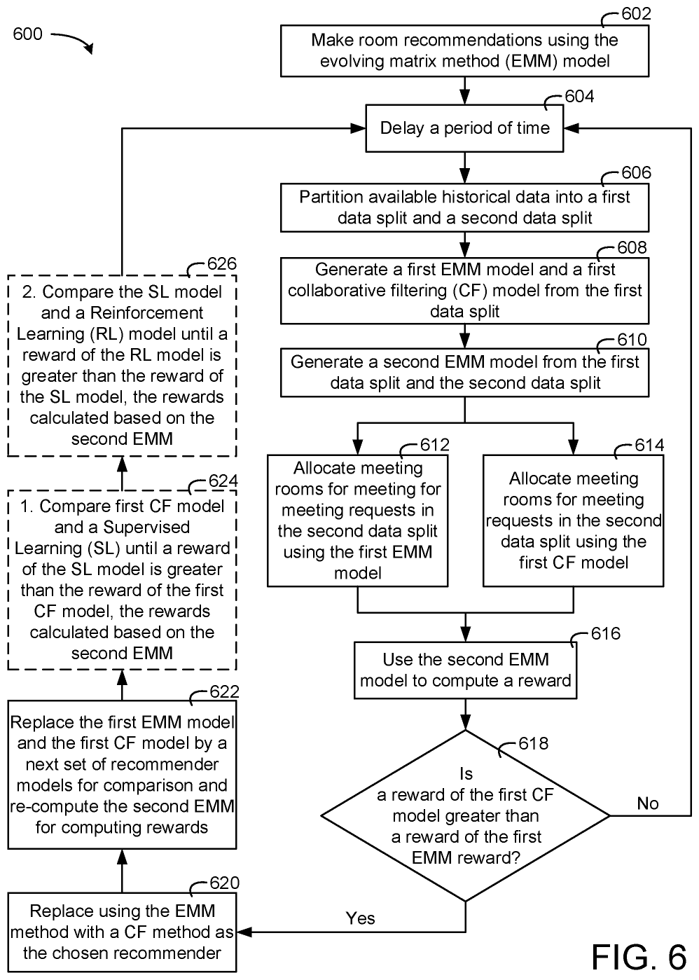

Referring now to FIG. 6, a process 600 of training recommendation models when no starting data is available that can be performed by the meeting room recommendation system of FIG. 4 is shown, according to an exemplary embodiment. In some embodiments, the meeting room recommendation system 400 is configured to perform the process 600. In some embodiments, any computing device described herein is configured to perform the process 600.

In step 602, the meeting room recommendation system 400 makes room recommendations using an EMM model, e.g., the EMM matrix 438 and/or the EMM matrix 300. The room recommendations can be made in response to a user request and/or in response to receiving a request from a system. The recommendations can be performed with the EMM method based on attendees of the meeting. The step 602 can be performed when the meeting room recommendation system 400 is first deployed to operate at a building or site when no training data or a small amount of training data is available, e.g., less than a predefined amount of training data is available.

In step 604, the meeting room recommendation system 400 can delay a period of time. For example, the meeting room recommendation system 400 can delay any other predefined number of days, weeks, months, etc. During the delay period, historical data can be collected. In step 606, the meeting room recommendation system 400 can partition the historical data into a first data split and a second data split. The data may be partitioned based on time. For example, for a four month period of data, the first three months of data can be assigned to the first data split while the fourth month of data can be assigned to the second data split.

In step 608, the meeting room recommendation system 400 can generate a first EMM model and a first CF model from the first data split. In step 610, the meeting room recommendation system 400 can generate a second EMM model from the first data split and the second data split. In some embodiments, the first data split and the second data split are based on time, i.e., the second data split can include real feedback data on a last day of the second data split. The second EMM model can be based on net total feedback data and can be used as a reference point (may be referred to as an “evolving reference model”) to compare the first EMM model and the first CF model. For example, the recommendations of the first EMM model and the first CF model can be compared to the recommendations of the second EMM model to determine how well each of the first EMM model and the first CF model are performing.

In step 612, the meeting room recommendation system 400 can allocate meeting rooms for meeting room requests in the second data split based on the first EMM model. In step 616, the meeting room recommendation system 400 can determine a reward for the first EMM model based on the second EMM model. This reward can indicate how well the first EMM model is performing. The second EMM model reward may be a good estimate of the actual feedback given by attendees during the second data split time period. It can be assumed that the feedback given by an attendee to a particular meeting room stays constant during the second data split.

In step 614, the meeting room recommendation system 400 can allocate meeting rooms for meeting requests in the second data split using the first CF model. In step 616, the meeting room recommendation system 400 can compute a reward of the first CF model and a reward of the first EMM with the second EMM. The rewards can indicate how closely recommendations of the first CF model and the first EMM match recommendations of the second EMM. The rewards can indicate how well the first CF model and the first EMM are performing. The allocations determined in the steps 612 and 614 determined in the first EMM model and the first CF model may be different than the actual allocations of the second data split.

In step 618, the meeting room recommendation system 400 can compare the reward of the first EMM model and the reward of the first CF model to determine whether the reward of the first CF model is greater than the reward of the first EMM reward. In some embodiments, the compared rewards are average rewards. If the reward of the first CF model is greater than the award of the first EMM model, the process can proceed to step 620.

If the reward of the first CF model is not greater than the award of the first EMM model, the process can return to the step 604. The process 600 can continue to perform the steps 604-616 until the reward of the first CF model is greater than the reward of the first EMM model. In step 620, the meeting room recommendation system 400 can replace using the EMM method with using a CF method for generating meeting room recommendations. Switching to using the CF method can include making recommendations with the first CF model or another CF model. After switching to using the CF model, the meeting room recommendation system 400 can update a matrix of the CF model periodically.

When a CF model starts performing better than an EMM, simulated experiments have shown that the CF model continues to perform better than EMM as more feedback data becomes available. Similarly, once a SL model starts performing better than a CF model, the SL model is expected to continue performing better than CF model as more feedback data is collected. Likewise, once an RL model starts performing better than the SL model, the RL model is expected to continue performing better than the SL model as more feedback data becomes available.

In step 622, the meeting room recommendation system 400 can replace the first EMM model and the first CF model by a next set of recommender models for comparison. For example, the procedure of steps 604-620 can be used to switch to other models, for example neural network recommender models. For example, as described in step 624, the first CF model and a SL model can be compared until the SL model outperforms the first CF model and the SL model is selected for use in generating recommendations. In step 626, the SL model and a RL model can be compared until the RL model outperforms the SL model and the RL model is selected. The steps 606-620 can be performed for the CF and SL models of step 624 and similarly for the RL and SL models of the step 626. However, throughout iterations, the second EMM can be re-computed. The second EMM can evolve as data is collected. The second EMM can be used to compute rewards for the comparisons of the first CF model and the first SL model and the first SL model and the first RL model respectively. In this regard, the second EMM may be an evolving reference model which performance of other models is compared to. The evolving reference model can provide a ground truth for comparing the performance of other models against. The reference model can be recomputed as data is collected and hence evolve. The evolving reference model may be a best feedback ratings matrix at a point in time.

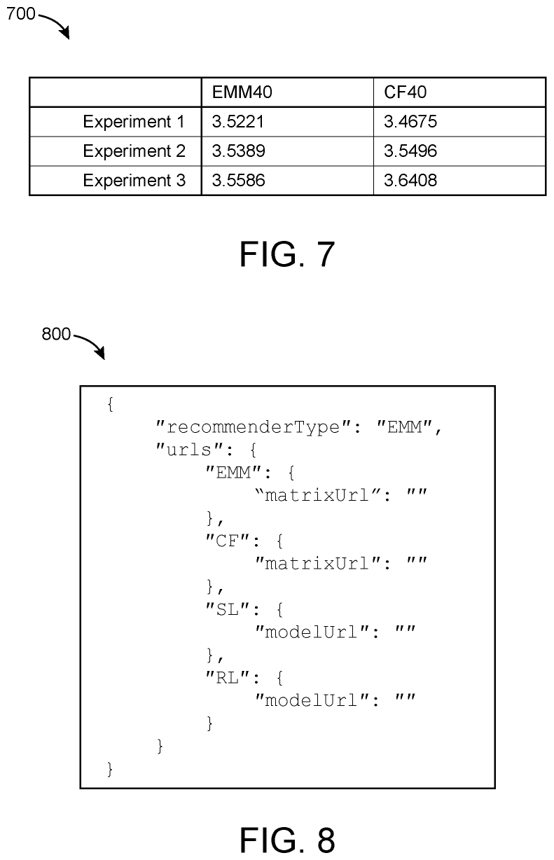

Referring now to FIG. 7, a chart 700 of multiple experiments where the meeting room recommendation system 400 switches between using a EMM model and a CF model is shown, according to an exemplary embodiment. The chart 700 illustrates an example implementation where the meeting room recommendation system 400 performs the process 600 on simulated data from a simulated building. In the example of FIG. 7, 40% of data of a correlated data set in a feedback matrix, a matrix of employee identifiers an meeting room identifier, is allocated to a first data split. A second data split is formed with 4,500 meeting room request with an average of six attendees.

The chart 700 illustrates three separate experiments. In the first experiment, 30% of attendees who attend meetings provide feedback. The reward scores for the EMM and the CF models are shown as 3.5221 and 3.44675 respectively. In the second experiment, 100% of attendees who attend the meetings provide feedback. However, the feedback matrix in this case is not full. In experiment three, the feedback matrix is filled with 100% ground truth data. In experiment two, it can be seen that the CF model outperforms the EMM model. The reward score of the CF model is 3.5496 while the reward score of the EMM is 3.5389. Because the reward score of the CF model is greater than the reward score of the EMM model, the meeting room recommendation system 400 can switch from operating with the EMM model to the CF model after experiment two is performed.

Referring now to FIG. 8, a code snippet 800 of URLs for an EMM model, a CF model, a SL model, and a RL model is shown, according to an exemplary embodiment. The code snippet 800 indicates URL locations for matrix locations, weight locations, and/or architecture files associated with one or more of the EMM model, the CF model, the SL model, and the RL model. In some embodiments, the URLs could be URLs for the CF matrix 440, the EMM matrix 438, the SL model file 444, and the RL model file 446. The operations engine 406 can be configured to retrieve the CF matrix 440, the EMM matrix 438, the SL model file 444, and the RL model file 446 based on the URLs.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed:

1. A building system comprising one or more memory devices configured to store instructions thereon, that, when executed by one or more processors, cause the one or more processors to:
generate building recommendations based on recommendation requests with a model of a first model type when less than a predefined amount of model training data is available;
receive feedback data on the recommendation requests generated by the model of the first model type; and
transition from generating the building recommendations by the model of the first model type to a second model of a second model type by comparing performance of the first model type to the second model type based on the feedback data.

2. The building system of claim 1, wherein comparing the performance of the first model type to the second model type based on the feedback data comprises comparing a first performance of a first model of the first model type and a second performance of the second model of the second model type to an evolving reference model of the first model type based on the feedback data.

3. The building system of claim 1, wherein the instructions cause the one or more processors to:
partition the feedback data into a first data set and a second data set;
generate first recommendations for recommendation requests of the second data set with a first model of the first model type based on the first data set;
generate second recommendations for the recommendation requests of the second data set with the second model of the second model type based on the first data set; and
compare performance of the first model of the first model type and the second model of the second model type by generating rewards of the first model and the second model with the first recommendations, the second recommendations, and an evolving reference model of the first model type, wherein the evolving reference model of the first model type is based on the first data set and the second data set.

4. The building system of claim 3, wherein the first model of the first model type and the evolving reference model of the first model type are both an evolving matrix method (EMM) model;
wherein the second model of the second model type is a collaborative filtering (CF) model.

5. The building system of claim 1, wherein the model is a matrix of an evolving matrix method (EMM);
wherein the instructions cause a plurality of values of the matrix to be updated overtime as the feedback data is collected.

6. The building system of claim 5, wherein the matrix comprises rows and columns, wherein one of the rows or the columns represent a plurality of users and one of the rows and the columns represent a plurality of possible recommendations.

7. The building system of claim 6, wherein each intersection of the rows and the columns represents the plurality of values;
wherein the instructions cause the one or more processors to:
receive a recommendation request associated with one or more users;
generate a score for each of the plurality of possible recommendations based on one or more of the plurality of values, the one or more of the plurality of values associated with the one or more users; and
select a possible recommendation associated with a highest score from the plurality of possible recommendations.

8. The building system of claim 1, wherein the instructions cause the one or more processors to:
receive second feedback data on second building recommendations generated by the second model of the second model type; and
transition from generating the second building recommendations by the second model of the second model type to a third model of a third model type by comparing performance of the second model type to the third model type based on the second feedback data and an evolving reference model of the first model type.

9. The building system of claim 8, wherein the second model of the second model type is a collaborative filtering (CF) model and the third model of the third model type is a supervised learning (SL) model.

10. The building system of claim 8, wherein the instructions cause the one or more processors to:
receive third feedback data on third building recommendations generated by the third model of the third model type; and
transition from generating the third building recommendations by the third model of the third model type to a fourth model of a fourth model type by comparing performance of the third model type to the fourth model type based on the third feedback data and the evolving reference model of the first model type.

11. The building system of claim 10, wherein the third model of the third model type is a supervised learning (SL) model and the fourth model of the fourth model type is a reinforcement learning (RL) model.

12. A method comprising:
generating, by a processing circuit, building recommendations based on recommendation requests with a model of a first model type when less than a predefined amount of model training data is available;
receiving, by the processing circuit, feedback data on the recommendation requests generated by the model of the first model type; and
transitioning, by the processing circuit, from generating the building recommendations by the model of the first model type to a second model of a second model type by comparing performance of the first model type to the second model type based on the feedback data.

13. The method of claim 12, wherein comparing the performance of the first model type to the second model type based on the feedback data comprises comparing a first performance of a first model of the first model type and a second performance of the second model of the second model type to an evolving reference model of the first model type based on the feedback data.

14. The method of claim 12, further comprising:
receiving, by the processing circuit, second feedback data on second building recommendations generated by the second model of the second model type; and
transitioning, by the processing circuit, from generating the second building recommendations by the second model of the second model type to a third model of a third model type by comparing performance of the second model type to the third model type based on the second feedback data and an evolving reference model of the first model type.

15. The method of claim 12, further comprising:
partitioning, by the processing circuit, the feedback data into a first data set and a second data set;
generating, by the processing circuit, first recommendations for recommendation requests of the second data set with a first model of the first model type based on the first data set;
generating, by the processing circuit, second recommendations for the recommendation requests of the second data set with the second model of the second model type based on the first data set; and
comparing, by the processing circuit, the performance of the first model of the first model type and the second model of the second model type by generating rewards of the first model and the second model with the first recommendations, the second recommendations, and an evolving reference model of the first model type, wherein the evolving reference model of the first model type is based on the first data set and the second data set.

16. The method of claim 15, wherein the first model of the first model type and the evolving reference model of the first model type are both an evolving matrix method (EMM) model;
wherein the second model of the second model type is a collaborative filtering (CF) model.

17. The method of claim 12, wherein the model is a matrix of an evolving matrix method (EMM);
wherein the method further comprises causing, by the processing circuit, a plurality of values of the matrix to be updated overtime as the feedback data is collected.

18. The method of claim 17, wherein the matrix comprises rows and columns, wherein one of the rows or the columns represent a plurality of users and one of the rows and the columns represent a plurality of possible recommendations.

19. The method of claim 18 wherein each intersection of the rows and the columns represents the plurality of values;
wherein the method further comprises:
receiving, by the processing circuit, a recommendation request associated with one or more users;
generating, by the processing circuit, a score for each of the plurality of possible recommendations based on one or more of the plurality of values, the one or more of the plurality of values associated with the one or more users; and
selecting, by the processing circuit, a possible recommendation associated with a highest score from the plurality of possible recommendations.

20. A building system comprising one or more memory devices configured to store instructions thereon, that, when executed by one or more processors, cause the one or more processors to:
generate building recommendations based on recommendation requests with a matrix of an evolving matrix method (EMM) when less than a predefined amount of model training data is available, wherein one of a row or a column of the matrix represents a plurality of users and one or more of the row or the column represent a plurality of possible recommendations;
receive feedback data on the recommendation requests generated by the matrix;
update a plurality of values of the matrix with the feedback data; and
generate additional building recommendations with the matrix updated based on the feedback data.
